(19) United States
(12) Patent Application Publication
(10) Pub. No.: US 2007/0182683 A1
(43) Pub. Date: Aug. 9, 2007

(54) Gamma voltage generating apparatus for display device

(75) Inventors: Heung-Suk Chin, Gyeonggi-do (KR); Hyun Lee, Seoul (KR); Soo-Myeong Kang, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/704,440

(22) Filed: Feb. 8, 2007

(30) Foreign Application Priority Data
Feb. 8, 2006 (KR) 2006-11906

(51) Int. Cl. G09G 3/36

(52) U.S. Cl. 345/88

(57) ABSTRACT

In an apparatus for generating a gamma voltage to enhance a display quality and a display device having the apparatus, the apparatus of the display device having a display panel and a plurality of driving chips mounted on the display panel, each of the driving chips having a data driving part for outputting a data signal, includes a plurality of gamma resistors, output terminals and a stabilizing circuit part. The gamma resistors are serially coupled between a power terminal and a ground terminal. The output terminals are directly connected to a data driving part for outputting distributed gamma voltages. The stabilizing circuit part is electrically connected to the output terminals and is mounted on a printed circuit board disposed on a side of the display panel for stabilizing the gamma voltages. Therefore, an output deviation among the driving chips is removed, so that the display quality can be enhanced.

### CROSS-REFERENCE TO RELATED APPLICATIONS

The present application claims priority from Korean Patent Application No. 2006-11906, filed on Feb. 8, 2006, the disclosure of which is hereby incorporated herein by reference in their entireties.

### FIELD OF THE INVENTION

The present invention relates to a display device having apparatus for generating a gamma voltage and, more particularly, generating a gamma voltage to enhance a display quality.

### DESCRIPTION OF THE RELATED ART

A typical liquid crystal display device includes an LCD panel having one or more integrated circuit chips mounted on the LCD panel for driving the LCD panel. The size and number of driving chip is dependent on the resolution and size of the LCD panel to be driven by the chip. Differences in the characteristics of the driving chips may result in different areas of the LCD panel having different contrast, resulting in poor display quality.

### SUMMARY OF THE INVENTION

The present invention provides a chip driving apparatus for generating a gamma voltage to reduce differences in gamma voltage output. In an exemplary embodiment of the present invention, a plurality of gamma voltages is distributed by serially-connected gamma resistors. A stabilizing circuit is mounted on a printed circuit board disposed at a side of the display panel for stabilizing the gamma voltages. The stabilizing circuit includes a plurality of external resistors having the same resistance ratio as that of the gamma resistors. The external resistors are serially coupled between the voltage terminal and the ground terminal, and a plurality of external capacitors electrically connected to the output terminals, respectively. Preferably, fewer external resistors may be provided than gamma resistors.

The apparatus may further include first and second output buffers, respectively connected to first and second output terminal outputting upper and lower gamma voltages having a first polarity among the output terminals, for buffering the upper and lower gamma voltages having a first polarity, to output the upper and lower gamma voltages to the data driving part, and third and fourth output buffer respectively connected to third and fourth output terminals outputting upper and lower gamma voltages having a second polarity among the output terminals, for buffering the upper and lower gamma voltages having the second polarity, to output the upper and lower gamma voltages into the data driving part.

In another example embodiment of the present invention, the apparatus of a display device having a display panel and a plurality of driving chips mounted on the display panel, each of the driving chips having a data driving part outputting a data signal into source lines of the display panel, the apparatus includes a plurality of gamma resistors, output terminals, a first and a second output buffers and a third and a fourth output buffers. The gamma resistors are formed in the driving chip and are serially coupled between a power terminal and a ground terminal. The output terminals are formed among the adjacent gamma resistors for outputting gamma voltages. First and second output buffers are respectively connected to first and second output terminal outputting upper and lower gamma voltage having a first polarity among the output terminals, for buffering the upper and lower gamma voltages having the first polarity, to output the upper and lower gamma voltages to the data driving part. Third and fourth output buffers are respectively connected to third and fourth output terminals outputting upper and lower gamma voltage having a second polarity among the output terminals, for buffering the upper and lower gamma voltages having the second polarity, to output the upper and lower gamma voltages into the data driving part.

In an example embodiment of the present invention, the display device having a display panel having source lines formed thereon, a plurality of driving chips mounted on the display panel and a printed circuit board connecting the display panel to an external device, the display device includes a plurality of gamma resistors, a stabilizing circuit part and a data driving part. The gamma resistors are formed in each of the driving chips, and are serially coupled between a voltage terminal and a ground terminal, for distributing the power voltages to a plurality of gamma voltages. The stabilizing circuit part is mounted on the printed circuit board, for stabilizing the gamma voltages. The data driving part is formed in the driving chip, for outputting a converted data signal based on the gamma voltages to a predetermined group of source lines.

Therefore, an output deviation among the driving chips is eliminated, so that the display quality can be enhanced.

### BRIEF DESCRIPTION OF THE DRAWINGS

The above and other features and advantages of the present invention will become more apparent from the ensuing description when read together with accompanying drawings, in which:

FIG. 1 is a view illustrating a display device according to an example embodiment of the present invention;

FIG. 2 is a block diagram illustrating the driving apparatus in FIG. 1;

FIG. 3 is a schematic circuit diagram on a gamma voltage generating part according to a first example embodiment of the present invention;

FIG. 4 is a gray scale gamma curvature diagram applied to the display device in FIG. 1;

FIG. 5 is a schematic circuit diagram on a gamma voltage generating part according to a second example embodiment of the present invention; and

FIG. 6 is a schematic circuit diagram on a gamma voltage generating part according to a third example embodiment of the present invention.

### DESCRIPTION OF THE EMBODIMENTS

In the drawings, the size and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

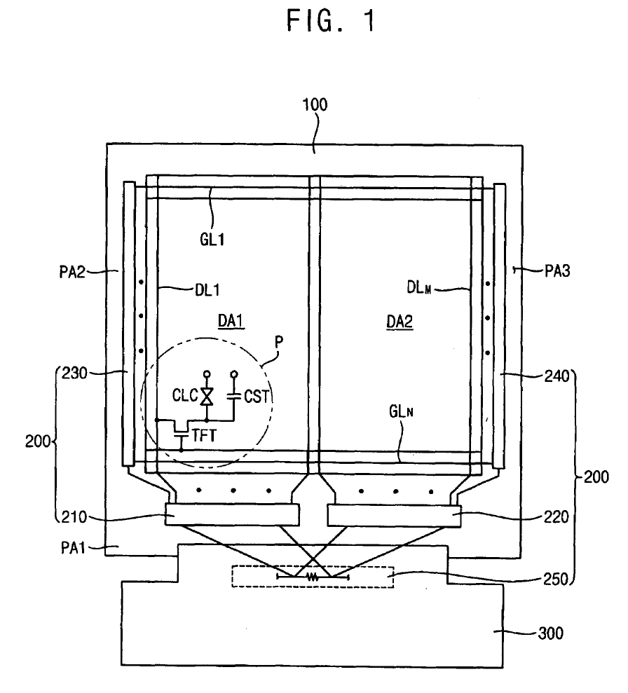

Referring to FIG. 1, a display panel 100 includes display areas DA1 and DA2 for displaying an image and peripheral areas PA1, PA2 and PA3 for surrounding the display areas DA1 and DA2. Display area DA has M×N pixel portions P defined by M source lines DL1˜DLM and N gate lines GL1˜GLN. Each of pixel portions P has a switching element TFT, a liquid capacitor CLC and a storage capacitor formed thereon.

An exemplary driving apparatus 200 includes a plurality of driving chips 210 and 220 mounted on a first peripheral area PA1, a plurality of gate circuit parts 230 and 240 mounted or integrated on a second peripheral area PA2 and a third peripheral area PA3, and a stabilizing circuit part 250 mounted on a flexible printed circuit board 300.

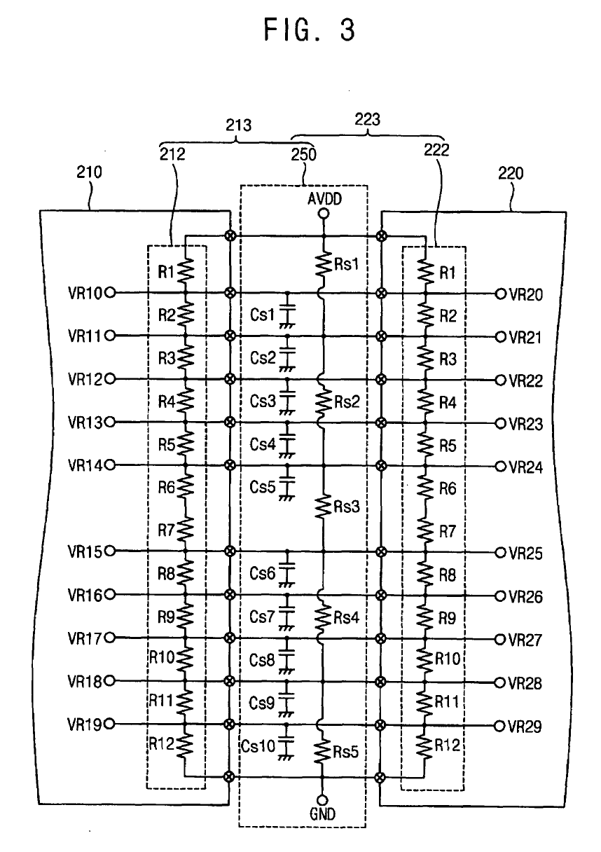

The first driving chip 210 outputs a first group of data signals to the first display area DA1 having a first group of source lines DL formed thereon. The second driving chip 220 outputs a second group of data signals to the second display area DA2 having a second group of source lines DL formed thereon. The first and second driving chips 210 and 220, as shown in FIG. 3, contain a plurality of gamma resistors that divide power voltage AVDD into a predetermined number of first gamma voltages and second gamma voltages. The first gate circuit part 230 sequentially outputs gate signals to a first group of gate signals GL. The second gate circuit part 240 sequentially outputs the gate signals to a second group of gate signals GL. For example, the first group of gate signals is an odd number of gate lines, and the second group of gate signals is an even number of gate lines.

The stabilizing circuit part 250 is mounted on the flexible printed circuit board 300 that electrically connects the driving chips 210 and 220 with an external device, for stabilizing the first and second gamma voltages generated in the first and second driving chips 210 and 220. The stabilizing circuit part 250 includes external resistors and external capacitors.

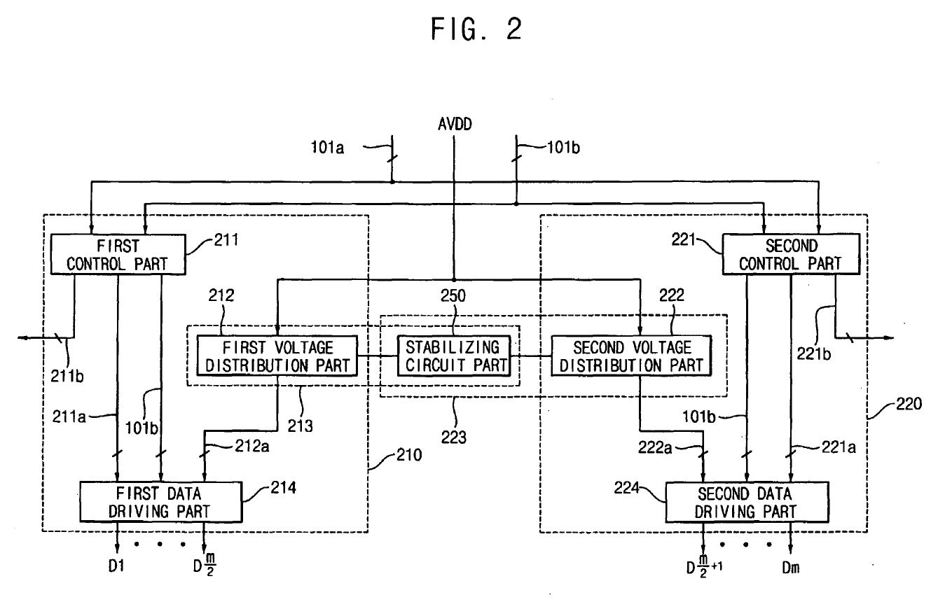

Referring to FIGS. 1 and 2, driving apparatus 200 includes the first driving chip 210, the second driving chip 220 and a stabilizing circuit board 250. The first driving chip 210 includes a first control part 211, a first voltage distribution part 212 and a first data driving part 214. The second driving chip 220 includes a second control part 221, a second voltage distribution part 222 and a second data driving part 224.

The driving apparatus includes a first gamma voltage generating part 213 and a second gamma voltage generating part 223 corresponding to the first and second driving chips 210 and 220. The first gamma voltage generating part 213 includes the first voltage distribution part 212 and the stabilizing part 250, and the second gamma voltage generating part 223 includes the second voltage distribution part 222 and the stabilizing part 250.

The first driving chip 210 receives a control signal 101a and a data signal 101b from the external device. The first control part 211 outputs a control signal 211a for controlling the first data driving part 214 and a control signal 211b for controlling the gate circuit part 230 based on the control signal 101a. The first control part 211 outputs the inputted data signal 101b to the first data driving part 214.

The first gamma voltage generating part 213 includes the first voltage distribution part 212 and the stabilizing circuit part 250. The first voltage distribution part 212 distributes the power voltage AVDD and a ground voltage GND provided from an external source into a plurality of first gamma voltages 212a, and outputs the first gamma voltages 212a. The stabilizing circuit part 250 is electrically connected to the first power distribution part 212, to stabilize the first gamma voltages 212a output from the first voltage distribution part 212.

The first data driving part 214 uses the first gamma voltages 212a for converting the data signal 101b provided from the first control part 211 into an analogue type of first data voltages D1˜DM/2, to output to a first data lines DL1˜DLM/2 of the first display area DA1.

The second driving chip 220 receives a control signal 101a and a data signal 101b from the external device. The second control part 221 outputs a control signal 221a for controlling the second data driving part 224 and a control signal 221b for controlling the gate circuit part 240 based on the control signal 101a. The second control part 221 outputs the inputted data signal 101b to the second data driving part 224.

The second gamma voltage generating part 223 includes the second voltage distribution part 222 and the stabilizing circuit part 250. The second voltage distribution part 222 distributes the power voltage AVDD and the ground voltage GND provided from the external source into a plurality of second gamma voltages 222a and outputs the second gamma voltages 222a. The stabilizing circuit part 250 is electrically connected to the second power distribution part 222, to stabilize the second gamma voltages 222a output from the second voltage distribution part 222.

The second data driving part 224 uses the second gamma voltages 222a for converting the data signal 101b provided from the second control part 221 into an analogue type of second data voltages DM/2+1˜DM, to output to a second data lines DLM/2+1˜DLM of the second display area DA2.

FIG. 3 is a schematic circuit diagram on a gamma voltage generating part according to a first example embodiment of the present invention.

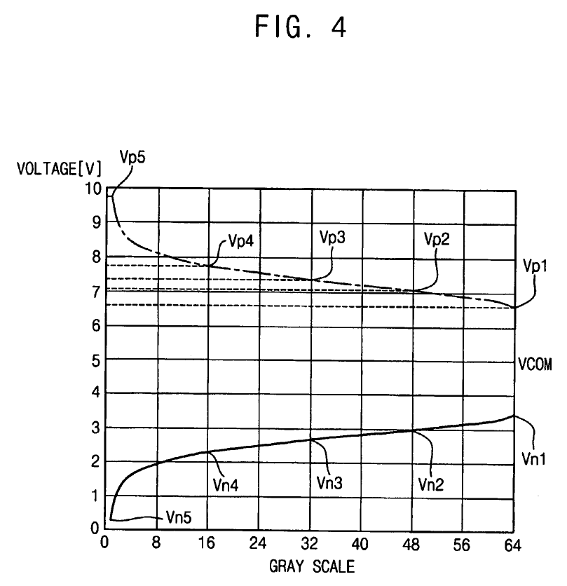

FIG. 4 is a gray scale gamma curvature diagram applied to the display device in FIG. 1.

Referring to FIGS. 1 to 4, the display device includes the first and second gamma voltage generating parts 213 and 223 corresponding to the first and second driving chips 210 and 220.

The first gamma voltage generating part 213 includes the first voltage distribution part 212 disposed in the first driving chip 210, and the stabilizing circuit part 250 mounted on the flexible printed circuit board 300. The first voltage distribution part 212 includes a plurality of first gamma resistors R1˜R12 serially coupled between the power voltage terminal AVDD and the ground voltage terminal GND, and first output terminals VR10˜VR19 formed among the adjacent first gamma voltages R1˜R12. First gamma voltages Vp5˜Vp1 and Vn1˜Vn5 are output to the first output terminals VR10˜VR19. Particularly, first, second, third, fourth and fifth terminal VR10, VR11, VR12, VR13 and VR14 among the first output terminals VR10˜VR19 output the first gamma voltages Vp5˜Vp1 having a first polarity corresponding to a reference voltage Vcom, and sixth, seventh, eighth, ninth and tenth terminal VR15, VR16, VR17, VR18 and VR19 among the first output terminals VR10˜VR19 output the first gamma voltages Vn1˜Vn5 having a second polarity corresponding to the reference voltage Vcom.

The stabilizing circuit part 250 includes external resistors Rs1˜Rs5 serially coupled between the power voltage terminal AVDD and the ground voltage terminal GND, and external capacitors Cs1˜Cs10 connected to the first output terminals VR10˜VR19 respectively. The external resistors Rs1˜Rs5 have a resistance ratio corresponding to that of the first gamma resistors R1˜R12. For example, the ratio (Rs1+ . . . +Rs5):(Rs1) is the same as the ratio (R1+ . . . +R12):(R1+R2). Thus, the external resistor Rs1 also distributes the first gamma voltages Vp5, Vp4 output to the first output terminals VR10, VR11. In addition, the external capacitors Cs1 and Cs2 connected to the first output terminals VR10, VR11 also remove ripple elements of the first gamma voltages Vp5 and Vp4.

The second voltage distribution part 222 includes a plurality of second gamma resistors R1˜R12 serially connected to the power voltage terminal AVDD and the ground voltage terminal GND, and second output terminals VR20˜VR29 formed among the adjacent second gamma resistors R1˜R12. Second gamma resistors R1˜R12 have substantially the same resistance ratio as the first gamma resistors.

Second gamma voltages Vp5˜Vp1, Vn1˜Vn5 are output through the second output terminals VR20˜VR29. Particularly, first, second, third, fourth and fifth terminals VR20, VR21, VR22, VR23 and VR24 among the second output terminals VR20˜VR29 output the second gamma voltages Vp5˜Vp1 having a first polarity corresponding to a reference voltage Vcom, and sixth, seventh, eighth, ninth and tenth terminals VR25, VR26, VR27, VR28 and VR29 among the second output terminals VR20˜VR29 output the second gamma voltages Vn1˜Vn5 having a second polarity corresponding to the reference voltage Vcom.

The external resistors Rs1˜Rs5 of the stabilizing circuit part 250 have a resistance ratio corresponding to that of the second gamma resistors R1˜R12. Thus, the external resistor Rs1 also distributes the second gamma voltages Vp5 and Vp4 output to the second output terminals VR10 and VR11. In addition, the external capacitors Cs1 and Cs2 connected to the second output terminals VR20 and VR21 also remove ripple elements of the second gamma voltages Vp5 and Vp4.

Hence, the gamma voltages, distributed by a gamma resistor string disposed in each driving chip, are stabilized by an external resistor string disposed outside of the driving chip and the stabilizing circuit part having the external capacitors. Accordingly, output buffers which would otherwise be needed to stabilize the gamma voltage are not necessary, and therefore the instability of the gamma voltage arising from differences in the output among the buffers is eliminated and since the driving deviation among the driving chips is removed it follows that contrast deviation in an image displayed by each driving chip is removed, so that the display quality can be enhanced.

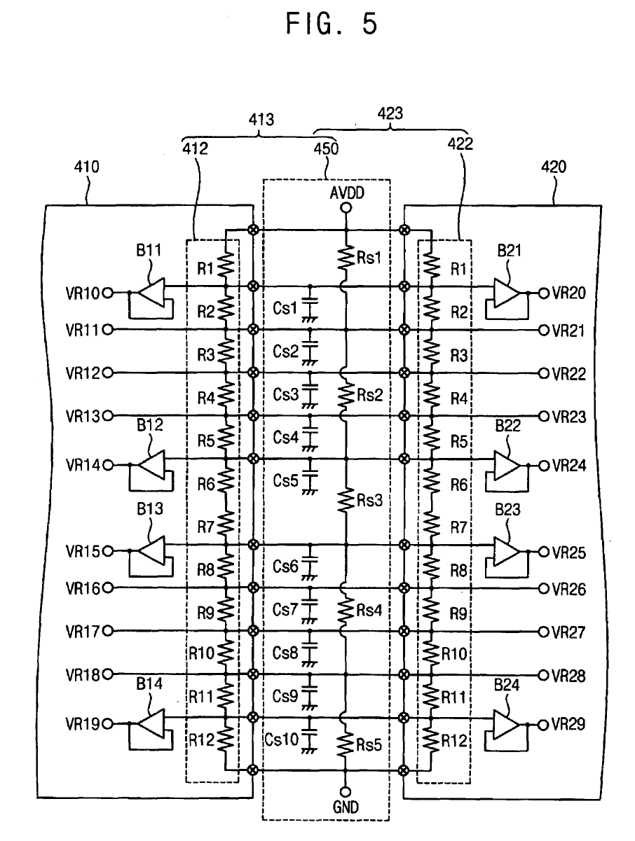

FIG. 5 is a schematic circuit diagram on a gamma voltage generating part according to a second example embodiment of the present invention.

Referring to FIGS. 4 and 5, the first gamma voltage generating part 413 includes a first voltage distribution part 412 disposed in the first driving chip (not shown) and a stabilizing circuit part 250 mounted on a flexible printed circuit board (not shown).

The first voltage distribution part 412 includes a plurality of first gamma resistors R1˜R12, first output terminals VR10˜VR19 and first, second, third and fourth output terminal B11, B12, B13 and B14. First, second, third, fourth and fifth terminals VR10, VR11, VR12, VR13 and VR14 among the first output terminals VR10˜VR19 output the first gamma voltages Vp5˜Vp1 having a first polarity corresponding to a reference voltage Vcom. Sixth, seventh, eighth, ninth and tenth terminals VR15, VR16, VR17, VR18 and VR19 among the first output terminals VR10˜VR19 output the first gamma voltages Vn1˜Vn5 having a second polarity corresponding to the reference voltage Vcom.

The first output buffer B11 is electrically connected to the output terminal VR10 outputting an upper level of first gamma voltage Vp5 among the first gamma voltages having a first polarity. The second output buffer B12 is electrically connected to the output terminal VR14 outputting a lower level of first gamma voltage Vp1 among the first gamma voltages having the first polarity. Thus, the first output buffer B11 buffers the first gamma voltage Vp5 for outputting the first gamma voltage Vp5, and the second output buffer B12 buffers the first gamma voltage Vp1 for outputting the first gamma voltage Vp1.

The third output buffer B13 is electrically connected to the output terminal VR15 outputting an upper level of first gamma voltage Vn1 among the first gamma voltages having a second polarity, and the fourth output buffer B14 is electrically connected to the output terminal VR14 outputting a lower level of first gamma voltage Vn5 among the first gamma voltages having the second polarity. Thus, the third output buffer B13 buffers the first gamma voltage Vn1 for outputting the first gamma voltage Vn1, and the fourth output buffer B14 buffers the first gamma voltage Vn5 for outputting the first gamma voltage Vn5.

The first, second, third and fourth output buffers B11, B12, B13 and B14 maintain the upper and lower level of gamma voltages having the first and second polarities to be always in a constant level, so that the gray scale of the data voltage converted by the first gamma voltages can be stabilized.

In the stabilizing circuit part 250, as explained in FIG. 3, the external resistors Rs1˜Rs5 distribute the first gamma voltages Vp5˜Vp1 and Vn1˜Vn5, and the external capacitors Cs1˜Cs10 remove the ripple element of the first gamma voltages Vp5˜Vp1 and Vn1˜Vn5. The first gamma voltage generating part 413 outputs first gamma voltages having greater uniformity.

The second voltage distribution part 422 includes a plurality of second gamma resistors R1˜R12, second output terminals VR20˜VR29 and fifth, sixth, seventh and eighth output terminal B21, B22, B23 and B24. First, second, third, fourth and fifth terminal VR20, VR21, VR212, VR23 and VR24 among the second output terminals VR20˜VR29 output the second gamma voltages Vp5˜Vp1 having a first polarity corresponding to a reference voltage Vcom, and the sixth to tenth terminals VR25˜VR29 among the second output terminals VR20˜VR29 output the second gamma voltages Vn1˜Vn5 having the second polarity corresponding to the reference voltage Vcom.

The fifth output buffer B21 is electrically connected to the output terminal VR20 outputting an upper level of second gamma voltage Vp5 among the second gamma voltages having the first polarity, and the sixth output buffer B22 is electrically connected to the output terminal VR24 outputting a lower level of second gamma voltage Vp1 among the second gamma voltages having the first polarity. Thus, the fifth output buffer B21 buffers the second gamma voltage Vp5 for outputting the second gamma voltage Vp5, and the sixth output buffer B22 buffers the second gamma voltage Vp1 for outputting the second gamma voltage Vp1.

The seventh output buffer B23 is electrically connected to the output terminal VR25 outputting an upper level of second gamma voltage Vn1 among the second gamma voltages having the second polarity, and the eight output buffer B24 is electrically connected to the output terminal VR24 outputting a lower level of second gamma voltage Vn5 among the second gamma voltages having the second polarity. Thus, the seventh output buffer B23 buffers the second gamma voltage Vn1 for outputting the second gamma voltage Vn1, and the eight output buffer B24 buffers the second gamma voltage Vn5 for outputting the second gamma voltage Vn5.

The fifth, sixth, seventh and eighth output buffers B21, B22, B23 and B24 maintains the upper and lower level of gamma voltages having the first and second polarity to have always a constant level, so that a gray scale of the data voltage converted by the second gamma voltages can be stabilized.

The stabilizing circuit part 250 distributes the second gamma voltages Vp5˜Vp1 and Vn1˜Vn5 more uniformly through the external resistors Rs1˜Rs5, and removes the ripple element of the second gamma voltages Vp5˜Vp1 and Vn1˜Vn5 through the external capacitors Cs1˜Cs10. Thus, the second gamma voltage generating part 423 outputs second gamma voltages having more uniformity.

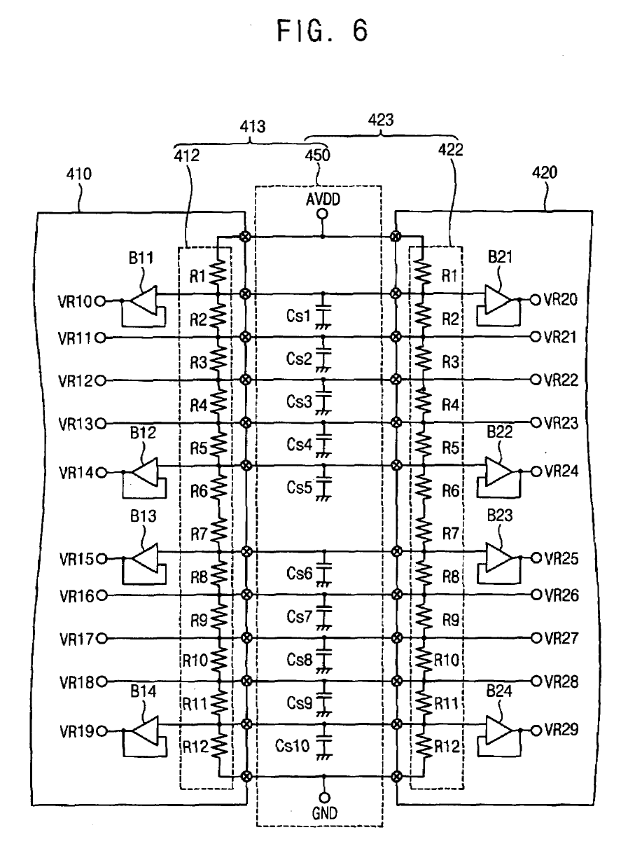

FIG. 6 is a schematic circuit diagram on a gamma voltage generating part according to a third example embodiment of the present invention.

Comparing the gamma voltage generating part of FIG. 6 with the gamma generating voltage part of FIG. 5, it is observed that the external resistors have been removed. Accordingly, the detailed description of the identical elements is omitted since the other elements are the same.

As in FIG. 5, the output buffer is electrically connected only to the output terminal outputting the highest and lowest gamma voltages among the output terminals of the gamma resistor string disposed in each driving chip so that the highest and lowest gamma voltages are maintained at a constant level.

In other words, the output buffer is electrically connected only to the output terminal of the highest and lowest gamma voltages, so that the instability of the gamma voltage due to the output deviation among the output buffers is minimized. In addition, the highest and lowest gamma voltages that are referenced to the data voltage, are maintained at a constant level, so that the gray scale deviation of the data voltage is minimized.

In addition, the stabilizing circuit part has the external resistor strings and/or the external capacitors disposed outside of the driving chip, so that the gamma voltage is stabilized.

Finally, the driving deviation among the driving chips is removed and the contrast deviation in the image displayed by each driving chip is removed, so that the display quality can be enhanced.

According to the present invention of the display device having the display panel driven by a plurality of driving chips, output deviation among the gamma voltages is removed resulting in less contrast deviation.

Particularly, the output buffer electrically connected to the output terminal of a distributing resistor string in each driving chip, is removed, and the stabilizing circuit part is formed in the external area of the driving chip having the external resistor string and the external capacitors, so that the gamma voltage distributed by the distributing resistor is intended to be stabilized. Thus, the driving deviation among the driving chips due to the output deviation among the output buffers, can be removed.

In addition, the output buffer is electrically connected only to the output terminals outputting the highest and lowest gamma voltages among the output terminals of the distributing resistor string in the driving chip, and the highest and lowest gamma voltages reference to the data voltage are maintained to a constant level, so that the gray scale of the data voltage can be stabilized and the output deviation among the output buffers can be minimized, therefore the driving deviation among the driving chips can be removed. Finally, the driving deviation among the driving chips is removed, so that the display quality of the display device can be enhanced.

Having described the example embodiments of the present invention and its advantage, it is noted that various changes, substitutions and alterations will be apparent to those skilled in the art and can be made herein without, however, departing from the spirit and scope of the invention.

What is claimed is:

1. An apparatus for generating a gamma voltage of a display device including a display panel and a plurality of driving chips mounted on the display panel, each of the driving chips including a data driving part for outputting a data signal to source lines of the display panel, the apparatus comprising:
a plurality of gamma resistors formed in the driving chip and serially coupled between a power terminal and a ground terminal;
output terminals, directly connected to the data driving part, for outputting gamma voltages to the data driving part, the gamma voltages being distributed by the gamma resistors; and
a stabilizing circuit part, electrically connected to the output terminals and mounted on a printed circuit board disposed at a side of the display panel, for stabilizing the gamma voltages.

2. The apparatus of claim 1, wherein the stabilizing circuit part includes a plurality of external capacitors respectively connected to the output terminals.

3. The apparatus of claim 2, wherein the stabilizing circuit part further includes a plurality of external resistors having the same resistance ratio as that of the gamma resistors, the external resistors being serially coupled between the voltage terminal and the ground terminal.

4. The apparatus of claim 3, wherein the number of the external resistors is smaller than that of the gamma resistors.

5. The apparatus of claim 1, further comprising:
first and second output buffers, respectively connected to first and second output terminals outputting upper and lower gamma voltages having a first polarity among the output terminals, for buffering the upper and lower gamma voltages having a first polarity to output the upper and lower gamma voltages to the data driving part; and
third and fourth output buffers, respectively connected to third and fourth output terminals outputting upper and lower gamma voltages having a second polarity among the output terminals, for buffering the upper and lower gamma voltages having the second polarity to output the upper and lower gamma voltages to the data driving part.

6. An apparatus for generating a gamma voltage of a display device including a display panel and a plurality of driving chips mounted on the display panel, each of the driving chips including a data driving part outputting a data signal to source lines of the display panel, the apparatus comprising:
a plurality of gamma resistors formed in the driving chip and serially coupled between a power terminal and a ground terminal;
output terminals, formed among the adjacent gamma resistances, for outputting gamma voltages;
first and second output buffers, respectively connected to first and second output terminals outputting upper and lower gamma voltages having a first polarity among the output terminals, for buffering the upper and lower gamma voltages having the first polarity to output the upper and lower gamma voltages to the data driving part; and
third and fourth output buffers, respectively connected to third and fourth output terminals outputting upper and lower gamma voltages having a second polarity among the output terminals, for buffering the upper and lower gamma voltages having the second polarity to output the upper and lower gamma voltages to the data driving part.

7. The apparatus of claim 6, further comprising a plurality of external capacitors mounted on a printed circuit board disposed at a side of the display panel, and respectively connected to the output terminals.

8. The apparatus of claim 7, further comprising a plurality of external resistors mounted on the printed circuit board, the external resistors having the same resistance ratio as that of the gamma resistors and being serially coupled between the voltage terminal and the ground terminal.

9. A display device including a display panel having source lines formed thereon, a plurality of driving chips mounted on the display panel and a printed circuit board connecting the display panel to an external device, the display device comprising:
a plurality of gamma resistors, formed in each of the driving chips, serially coupled between a voltage terminal and a ground terminal, for distributing the power voltages to a plurality of gamma voltages;
a stabilizing circuit part, mounted on the printed circuit board, for stabilizing the gamma voltages; and
a data driving part, formed in the driving chip, for outputting a converted data signal based on the gamma voltages to a predetermined group of source lines.

10. The display device of claim 9, wherein the stabilizing circuit part includes a plurality of external capacitors respectively connected to output terminals through which the gamma voltages are output.

11. The display device of claim 10, wherein the number of the external resistors is smaller than that of the gamma resistors.

12. The display device of claim 10, further comprising a plurality of external resistors having the same resistance ratio as that of the gamma resistors and being serially coupled between the voltage terminal and the ground terminal.

13. The display device of claim 9, further comprising:
output terminals, formed among the adjacent gamma resistances, for outputting gamma voltages;
first and second output buffers, respectively connected to first and second output terminals outputting upper and lower gamma voltages having a first polarity among the output terminals, for buffering the upper and lower gamma voltages having the first polarity to output the upper and lower gamma voltages to the data driving part; and
third and fourth output buffers, respectively connected to third and fourth output terminals outputting upper and lower gamma voltages having a second polarity among the output terminals, for buffering the upper and lower gamma voltages having the second polarity to output the upper and lower gamma voltages to the data driving part.

14. A driver for a display including a circuit for stabilizing gamma voltages, comprising:
a group of series-connected resistances for dividing an input voltage into a plurality of gamma voltages; and
an output buffer connected at each end of a group of the resistances.
